(19) United States
(12) Patent Application Publication
(10) Pub. No.: US 2005/0273180 A1
(43) Pub. Date: Dec. 8, 2005

(54) System and method for starting up plural electronic devices in an orderly manner

(75) Inventors: Shun-Fu Tung, Tu-Cheng (TW); Sheng-Hung Yang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/117,219

(22) Filed: Apr. 28, 2005

(30) Foreign Application Priority Data
Jun. 8, 2004 (CN) 200410051042.4

(51) Int. Cl. G05B 19/18

(52) U.S. Cl. 700/3

(57) ABSTRACT

A system for starting up plural electronic devices in an orderly manner includes four power switches (18, 28, 38, 48) connected to a common power source (17) and respective hard drives (19, 29, 39, 49), and four microprocessors (16, 26, 36, 46) respectively connected to the power switches and to delay-setting modules (15, 25, 35, 45) for controlling preset time delays of the corresponding microprocessors. Each of the microprocessors is configured for outputting a low voltage level to the corresponding power switch for switching on an electronic connectivity between the power source and the corresponding hard drive after a unique preset time delay has elapsed. A related method for starting up plural electronic devices in an orderly manner is also provided.

### BACKGROUND OF THE INVENTION

1. Field of the Invention

The present invention is related to systems and methods for starting up electronic devices, and particularly to a system and method for starting up plural electronic devices in an orderly manner.

2. Description of Related Art

Generally, users of computer systems store their data in storage devices of the computer systems. When the data exceed the capacity of the storage devices, the users can connect extra plural storage devices in parallel in order to enlarge the capacity of the original storage devices. The storage devices may be hard disk drives (“hard drives”), or other storage devices known in the art.

Each storage device needs a driving current; for example, the driving current of a typical hard drive is 2 amperes. If the users connect two hard drives in parallel, when the hard drives are driven by their respective motors simultaneously, the total instantaneous peak-value current is 4 amperes. If the users only connect relatively few hard drives, the total driving current needed can be easily supplied by a standard power source. However, if the users connect relatively many hard drives, the total instantaneous peak-value current is correspondingly high. For example, the total instantaneous peak-value current of eight hard drives connected to the power source is 16 amperes. Standard power sources are not able to supply such a strong current. Therefore, the users must employ special storage devices such as SCSI (small computer systems interface) hard drives, or Fiber Channel hard drives. However, the purchase costs of such hard drives are high.

Consequently, a system and method are needed for starting up plural storage devices in an orderly manner so as to decrease the total instantaneous peak-value current required when the plural storage devices are started up.

### SUMMARY OF THE INVENTION

A first objective of the present invention is to provide a system for starting up plural electronic devices in an orderly manner.

A second objective of the present invention is to provide a method for starting up plural electronic devices in an orderly manner.

In order to fulfill the above-mentioned first objective, the present invention provides a system for starting up plural electronic devices in an orderly manner. The system comprises a first backboard and a second backboard. The first backboard comprises: a first electronic device; a first power switch connected to the first electronic device; a first microprocessor connected to the first power switch, the first microprocessor comprising an input end and an output end, the input end being for receiving a high voltage level; and a first delay-setting module for controlling preset time delays of the first microprocessor. The second backboard comprises: a second electronic device; a second power switch connected to the second electronic device; a second microprocessor connected to the second power switch, the second microprocessor comprising an input end and an output end, the input end being for receiving a high voltage level from the output end of the first microprocessor; and a second delay-setting module for controlling one or more preset time delays of the second microprocessor. The system further comprises a power source connected to the first power switch and the second power switch in parallel. The first microprocessor is configured for outputting a low voltage level to the first power switch for switching on an electronic connectivity between the power source and the first electronic device after a first preset time delay has elapsed, and the second microprocessor is configured for outputting the low voltage level to the second power switch for switching on an electronic connectivity between the power source and the second electronic device after a third preset time delay has elapsed.

Further, the first microprocessor outputs the high voltage level to the input end of the second microprocessor after a second preset time delay has elapsed, which occurs after the first preset time has elapsed and before the third preset time delay has elapsed. This triggers the second microprocessor to output the low voltage level to the second power switch, and ensures that such outputting after the third preset time delay has elapsed is clearly later that the outputting of the low voltage level by the first microprocessor to the first power switch after the first preset time delay has elapsed.

In order to fulfill the above-mentioned second objective, the present invention provides a method for starting up plural electronic devices in an orderly manner. The method comprises the steps of: (a) outputting by a first microprocessor of a high voltage level to respective power switches, for switching off corresponding electronic connectivity between a power source and the electronic devices; (b) receiving the high voltage level at an input end of the first microprocessor; (c) outputting a low voltage level from the first microprocessor to the first power switch after a first time delay has elapsed, for switching on the corresponding electronic connectivity between the power source and one or more respective electronic devices; (d) receiving the high voltage level at an input end of a second microprocessor after a second preset time delay; (e) outputting the low voltage level by the second microprocessor to a second power switch after a preset third time delay, for switching on the corresponding electronic connectivity between the power source and one or more respective electronic devices.

Other objectives, advantages and novel features of the present invention will become more apparent from the following detailed description when taken in conjunction with the accompanying drawings, in which:

### BRIEF DESCRIPTION OF THE DRAWINGS

FIG. 1 is a schematic diagram of hardware infrastructure of an exemplary embodiment of a system for starting up plural electronic devices in an orderly manner according to the present invention;

FIG. 2 is a diagram of input voltage levels and output voltage levels of four microprocessors of the system of FIG. 1, plotted in relation to lapse of time; and

FIG. 3 is a flow chart of an exemplary method for starting up plural electronic devices in an orderly manner according to the present invention.

### DETAILED DESCRIPTION OF THE EMBODIMENT

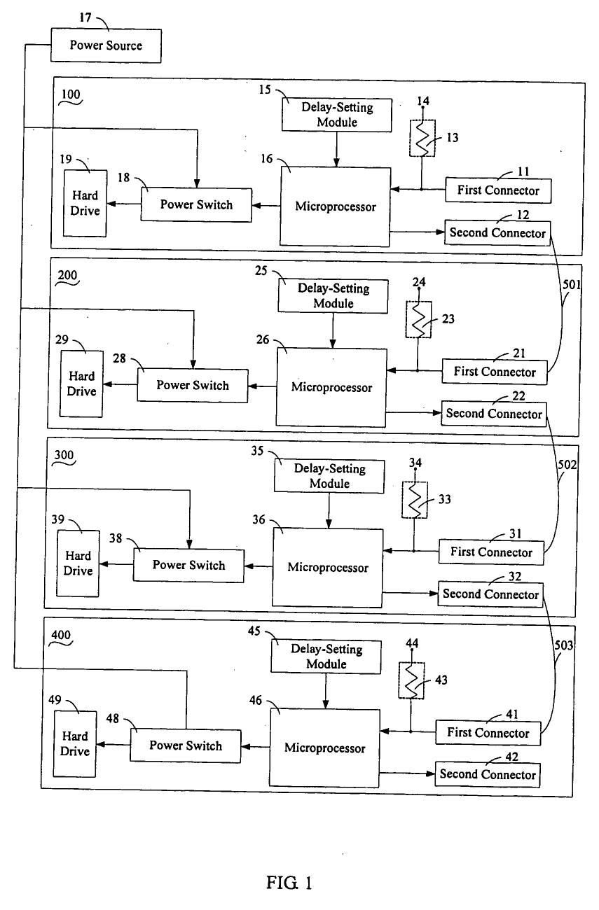

FIG. 1 is a schematic diagram of hardware infrastructure of the exemplary embodiment of a system for starting up plural electronic devices in an orderly manner according to the present invention. In the exemplary embodiment, the system comprises four backboards: a first backboard 100, a second backboard 200, a third backboard 300, and a fourth backboard 400. The first backboard 200 is electronically connected to the second backboard 100 by a parallel line 501. The second backboard 200 is electronically connected to the third backboard 300 by a parallel line 502. The third backboard 300 is electronically connected to the fourth backboard 400 by a parallel line 503. In the preferred embodiment, the electronic devices started up are four hard drives 19, 29, 39 and 49 that are respectively disposed on the four backboards 100, 200, 300 and 400.

The first backboard 100 mainly comprises a first connector 11, a second connector 12, a microprocessor 16, a power switch 18, and the hard drive 19. The first connector 11 is electronically connected to the microprocessor 16 for inputting logic voltage levels thereto. The microprocessor 16 is electronically connected to the power switch 18. The power switch 18 is electronically connected to the hard drive 19. Under control of the microprocessor 16, the power switch 18 switches on or off an electronic connectivity of the hard drive 19 with a power source 17. When the power switch 18 switches on said electronic connectivity, the hard drive 19 starts up. After the power switch 18 switches on said electronic connectivity, the microprocessor 16 outputs the logic voltage levels to the second connector 12. In addition, the backboard 100 comprises a pull-up resistor 13 and a delay-setting module 15. One end of the pull-up resistor 13 is electronically connected to the microprocessor 16 together with the first connector 11 in parallel, and the other end of the pull-up resistor 13 is electronically connected to a high voltage level node 14. The delay-setting module 15 is electronically connected to the microprocessor 16. A user presets time delays of the delay-setting module 15 before the system is started up. Upon expiry of the time delays, the microprocessor 16 outputs a high voltage level and a low voltage level as required. In the exemplary embodiment, the microprocessor 16 receives a high logic voltage level from the first connector 11, and outputs a low logic voltage level to the power switch 18 for switching on the electronic connectivity of the hard drive 19 with the power source 17. In an alternative embodiment, the microprocessor 16 may be configured to receive a low voltage level from the first connector 11, and output a high voltage level to the power switch 18 for switching on said electronic connectivity.

In the exemplary embodiment, the second backboard 200, the third backboard 300, and the fourth backboard 400 have similar structures to that of the first backboard 100, as seen in FIG. 1. Like reference numerals correspond to like components. For the sake of brevity, the second, third and fourth backboards 200, 300, and 400 are not fully described in detail herein. The second connector 12 of the first backboard 100 is electronically connected to a first connector 21 of the second backboard 200 through the parallel line 501. A second connector 22 of the second backboard 200 is electronically connected to a first connector 31 of the third backboard 300 through the parallel line 502. A second connector 32 of the third backboard 300 is electronically connected to a first connector 41 of the fourth backboard 400 through the parallel line 503. Power switches 18, 28, 38 and 48 on the corresponding backboards 100, 200, 300 and 400 are commonly connected to the power source 17.

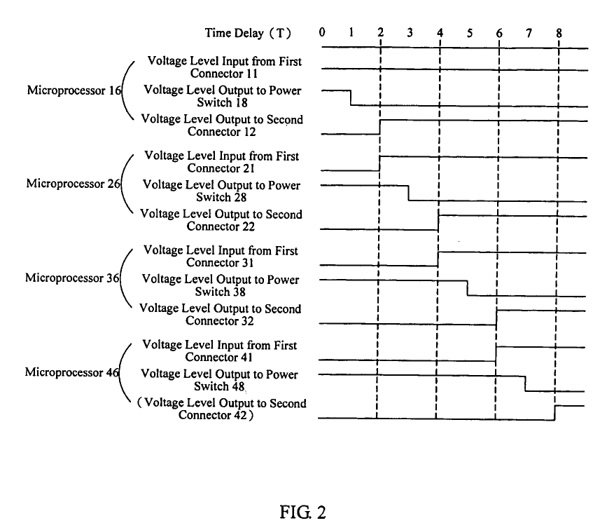

FIG. 2 is a diagram of input voltage levels and output voltage levels of four microprocessors 16, 26, 36 and 46 plotted in relation to lapse of time. The lapse of time is called a “time delay” (“T”), and is measured from a moment at which the microprocessor 16 receives a high voltage level from the first connector 11. The microprocessors 16, 26, 36 and 46 can control the switching sequence of the power switches 18, 28, 38 and 48 according to the logic voltage levels received from the first connectors 11, 21, 31 and 41 and the time delay controlled by the delay-setting modules 15, 25, 35 and 45. As a result, the hard drives 19, 29, 39 and 49 connected to the corresponding power switches 18, 28, 38 and 48 are started up in an orderly manner.

In the preferred embodiment, when the system is started up, the power source 17 provides power for the power switches 18, 28, 38 and 48 on the backboards 100, 200, 300 and 400 respectively, the microprocessors 16, 26, 36 and 46 on the corresponding backboards 100, 200, 300 and 400 output a high logic voltage level to the corresponding power switches 18, 28, 38 and 48, and the microprocessors 16, 26 and 36 output a low logic voltage level to the corresponding second connectors 12, 22 and 32. This occurs because the second connectors 12, 22 and 32 interconnect with the first connectors 21, 31 and 41 on the next backboards 200, 300 and 400 via the parallel lines 501, 502 and 503.

In particular, the sequence of transmission of low voltage levels is as follows. The microprocessor 16 outputs a low logic voltage level to the second connector 12. Through the parallel line 501, the first connector 21 connected to the microprocessor 26 on the backboard 200 receives the low logic voltage level from the second connector 12. Thus the microprocessor 26 receives the low logic voltage level, and outputs a low logic voltage level to the second connector 22. Through the parallel line 502, the first connector 31 connected to the microprocessor 36 on the backboard 300 receives the low logic voltage level from the second connector 22. Thus the microprocessor 36 receives the low logic voltage level, and outputs a low logic voltage level to the second connector 32. Through the parallel line 503, the first connector 41 connected to the microprocessor 46 on the backboard 400 receives the low logic voltage level from the second connector 32. Thus, the microprocessor 46 receives the low logic voltage level. Accordingly, the microprocessors 26, 36 and 46 on the corresponding backboards 200, 300 and 400 receive the low logic voltage levels from the corresponding first connectors 21, 31 and 41 at the moment the power source 17 is turned on. Thus the power switches 28, 38 and 48 switch off the electronic connectivity of the hard drives 29, 39 and 49 with the power source 17, because the power switches 28, 38 and 48 receive the high logic voltage levels from the microprocessors 26, 36 and 46.

Further, first ends of the pull-up resistors 13, 23, 33 and 43 are connected to the high logic voltage level nodes 14, 24, 34 and 44. The pull-up resistors 13, 23, 33 and 43 are used for providing the microprocessors 16, 26, 36 and 46 with high voltage levels when the microprocessors 16, 26, 36 and 46 do not receive the high voltage levels or low voltage levels from the first connectors 11, 21, 31 and 41. Because an input end of the first connector 11 is unconnected, the microprocessor 16 cannot receive any low logic voltage level. On the other hand, because the pull-up resistor 13 is connected to the high logic voltage node 14, the microprocessor 16 receives a high logic voltage level from the pull-up resistor 13.

The microprocessors 16, 26, 36 and 46 are configured with different pre-determined time delays controlled by the delay-setting modules 15, 25, 35 and 45. On the first backboard 100, when the microprocessor 16 receives a high logic voltage level from the first connector 11, the microprocessor 16 outputs a low logic voltage level to the power switch 18 after a first time delay such as T=0.1 seconds. The power switch 18 immediately switches on the electronic connectivity of the hard drive 19 with the power source 17. Thus, the hard drive 19 starts up.

After a second time delay such as T=0.2 seconds, the microprocessor 16 outputs a high logic voltage level to the second connector 12. Accordingly, the microprocessor 26 on the second backboard 200 receives the high logic voltage level from the first connector 21 through the parallel line 501. After a third time delay such as T=0.3 seconds, the microprocessor 26 outputs a low logic voltage level to the power switch 28. The power switch 28 immediately switches on the electronic connectivity of the hard drive 29 with the power source 17. Thus, the hard drive 29 starts up.

After a fourth time delay such as T=0.4 seconds, the microprocessor 26 outputs a high logic voltage level to the second connector 22. Accordingly, the microprocessor 36 on the third backboard 300 receives the high logic voltage level from the first connector 31 through the parallel line 502. After a fifth time delay such as T=0.5 seconds, the microprocessor 36 outputs a low logic voltage level to the power switch 38. The power switch 38 immediately switches on the electronic connectivity of the hard drive 39 with the power source 17. Thus, the hard drive 39 starts up.

After a sixth time delay such as T=0.6 seconds, the microprocessor 36 outputs a high logic voltage level to the second connector 32. Accordingly, the microprocessor 46 on the fourth backboard 400 receives the high logic voltage level from the first connector 41 through the parallel line 503. After a seventh time delay such as T=0.7 seconds, the microprocessor 46 outputs a low logic voltage level to the power switch 48. The power switch 48 immediately switches on the electronic connectivity of the hard drive 49 with the power source 17. Thus, the hard drive 49 starts up.

Thus, starting up of the hard drives 19, 29, 39 and 49 in an orderly manner is realized. If the system had a fifth backboard, then after an eighth time delay such as T=0.8 seconds, the microprocessor 46 would output a high logic voltage level to the second connector 42.

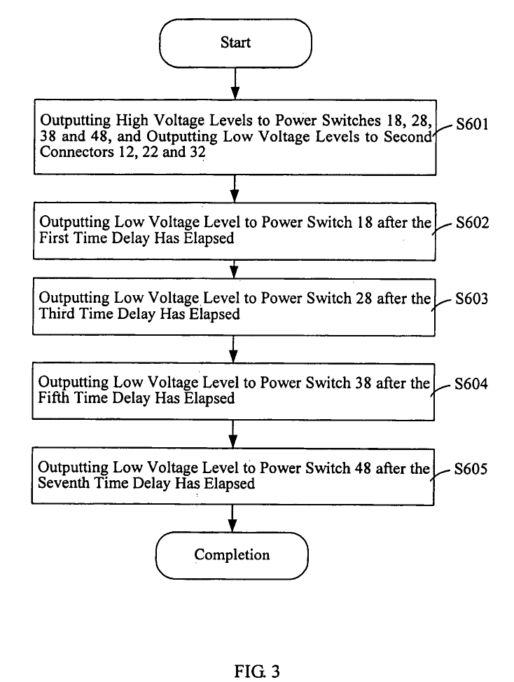

FIG. 3 is a flow chart of the exemplary method for starting up the plural hard drives in an orderly manner according to the present invention. The method is implemented using the above-described exemplary system. At step 601, when the power source 17 is powered on, the microprocessors 16, 26, 36 and 46 output high voltage levels to the corresponding power switches 18, 28, 38 and 48, and simultaneously the microprocessors 16, 26 and 36 output low voltage levels to the corresponding second connectors 12, 22, 32. At step S602, the microprocessor 16 outputs a low voltage level to the power switch 18 after the first time delay has elapsed. Thus, the hard drive 19 is started up. At step S603, the microprocessor 26 outputs a low voltage level to the power switch 28 after the third time delay has elapsed. Thus, the hard drive 29 is started up. At step S604, the microprocessor 36 outputs a low voltage level to the power switch 38 after the fifth time delay has elapsed. Thus, the hard drive 39 is started up. At step S605, the microprocessor 46 outputs a low voltage level to the power switch 48 after the seventh time delay has elapsed. Thus, the hard drive 49 is started up. This completes implementation of the method, with the hard drives 19, 29, 39 and 49 started up in an orderly manner.

While a particular embodiment and particular method of the present invention have been described above, it should be understood that they have been presented by way of example only and not by way of limitation. Thus the breadth and scope of the present invention should not be limited by the above-described exemplary embodiment and method, but should be defined only in accordance with the following claims and their equivalents.

1. A method to start up a plurality of electronic devices in a predetermined order, comprising the steps of:
controlling starting-up of each of said plurality of electronic devices by using a corresponding microprocessor to control power supply of said each of said plurality of electronic device respectively;
electrically connecting said corresponding microprocessors of said plurality of electronic devices with one another in said predetermined order so that a following one of said corresponding microprocessors is capable of retrieving a signal to enable from a previous one of said corresponding microprocessors based on said predetermined order;
enabling said previous one of said corresponding microprocessors to allow said previous one of said corresponding microprocessors being capable of starting up one of said plurality of electronic devices corresponding thereto, and capable of generating said signal to said following one of said corresponding microprocessors so as to enable said following one of said corresponding microprocessors; and
continuing said enabling step until all of said corresponding microprocessors of said plurality of electronic devices retrieve said signal to enable and subsequently start up said plurality of electronic devices corresponding thereto.

2. The method as recited in claim 1, further comprising the step of starting up said each of said plurality of electronic devices after a preset time delay elapses in case that said corresponding microprocessor of said each of said plurality of electronic devices retrieves said signal to enable.

3. The method as recited in claim 1, further comprising the step of generating said signal to enable by said previous one of said corresponding microprocessors to said following one of said corresponding microprocessors after a preset time delay elapses in case that said previous one of said corresponding microprocessors has started up said one of said plurality of electronic devices corresponding thereto.

4. A system for starting up plural electronic devices in an orderly manner, the system comprising:
a plurality of power switches, each of which is connected to a common power source and at least one electronic device, for switching an electronic connectivity between the power source and the at least one electronic device on and off;
a plurality of microprocessors respectively connecting to the power switches, each of the microprocessors comprising an input end for receiving a first voltage level, and each of the microprocessors that is sequenced before a last one of the microprocessors comprising an output end; and
a plurality of delay-setting modules, each for controlling at least one time delay of a respective microprocessor;
wherein each of the microprocessors is configured for outputting a second voltage level to the corresponding power switch to switch on an electronic connectivity between the power source and the corresponding at least one electronic device after a preset time delay has elapsed from the moment of receiving the first voltage level.

5. The system as recited in claim 4, wherein each of the microprocessors except the last microprocessor outputs the first voltage level to the input end of a next microprocessor when a preset time delay has elapsed from the moment of switching on of the electronic connectivity between the power source and the corresponding at least one electronic device.

6. The system as recited in claim 4, wherein each of the microprocessors except the last microprocessor outputs the second voltage level via the output end thereof when the power source is powered on.

7. The system as recited in claim 4, wherein each of the backboards comprises a pull-up resistor, which has one end connected to the input end of the corresponding microprocessor, and another end connected to a high voltage node.

8. A method for starting up plural electronic devices in an orderly manner, the method comprising the steps of:
(a) outputting a first voltage level to respective power switches, for switching off corresponding electronic connectivities between a power source and the electronic devices;
(b) receiving the first voltage level at an input end of a first microprocessor;
(c) outputting a second voltage level from the first microprocessor to a first power switch after a first time delay has elapsed, for switching on the corresponding electronic connectivity between the power source and one or more respective electronic devices;
(d) receiving the first voltage level at an input end of a second microprocessors after a second time delay;
(e) outputting the second voltage level by the second microprocessor to a second power switch after a third time delay, for switching on the corresponding electronic connectivity between the power source and one or more respective electronic devices; and
(f) repeating the above-described steps (b), (c), (d) and (e) if and as necessary for any further microprocessor, respective power switch and corresponding electronic connectivity between the power source and one or more respective electronic devices;
wherein the first, second and third time delays are each measured from the same point in time, being a time at which the first microprocessor receives the first voltage level at its input end.
